(19) United States
(12) Patent Application Publication
(10) Pub. No.: US 2026/0304045 A1
(43) Pub. Date: Oct. 1, 2026

(54) Adaptive Improvement For Personalized Sound Processing by a Hearing Device

(71) Applicant: SONOVA AG, Staefa (CH)

(72) Inventors: Stefan Klockgether, Hombrechtikon (CH); Daniel Lucas-Hirtz, Jona (CH)

(21) Appl. No.: 19/095,974

(22) Filed: Mar. 31, 2025

(51) Int. Cl. H04R 25/00

(52) U.S. Cl. CPC H04R 25/502; H04R 2225/43

(57) ABSTRACT

An exemplary method includes a processor associated with a hearing device worn by a user performing an adjustment to a target signal separation algorithm applied to an input signal to the hearing device, determining, by the processor, an own voice sound level representative of a sound level of a voice of the user, and performing, by the processor and based on the own voice sound level, an operation with respect to the adjustment.

### BACKGROUND INFORMATION

Hearing devices (e.g., hearing aids) are used to improve the hearing capability and/or communication capability of users of the hearing devices. Such hearing devices are configured to process a received input sound signal (e.g., ambient sound) and provide the processed input sound signal to the user (e.g., by way of a receiver (e.g., a speaker) placed in the user’s ear canal or at any other suitable location).

Hearing devices may apply various target signal separation algorithms for processing sound received as input to the hearing device to provide as output to the user. However, such target signal separation algorithms may generally include room for improvement. But improving such target signal separation algorithms may be difficult, as proper evaluation of the target signal separation algorithms may entail controlled experiments and/or environments that provide feedback to changes made to the target signal separation algorithms. Further, audio signals processed by the algorithms may be perceived differently by different users based on hearing loss profiles and/or other factors.

### BRIEF DESCRIPTION OF THE DRAWINGS

The accompanying drawings illustrate various embodiments and are a part of the specification. The illustrated embodiments are merely examples and do not limit the scope of the disclosure. Throughout the drawings, identical or similar reference numbers designate identical or similar elements.

FIG. 1 illustrates an exemplary hearing system that may be implemented according to principles described herein.

FIG. 2 illustrates an exemplary implementation of the hearing system of FIG. 1 according to principles described herein.

FIG. 3 illustrates an exemplary hearing device according to principles described herein.

FIG. 4 illustrates an exemplary hearing device according to principles described herein.

FIG. 5 illustrates an exemplary hearing device according to principles described herein.

FIG. 6 illustrates an exemplary method according to principles described herein.

FIG. 7 illustrates an exemplary method according to principles described herein.

FIG. 8 illustrates an exemplary computing device according to principles described herein.

### DETAILED DESCRIPTION

Systems and methods for adaptive improvement for improved, e.g., personalized, target signal separation by a hearing device are described herein. As will be described in more detail below, an exemplary system may comprise a memory storing instructions and a processor communicatively coupled to the memory and configured to execute the instructions to perform a process. The process may comprise performing an adjustment to a target signal separation algorithm applied to an input signal to a hearing device worn by a user, determining an own voice sound level representative of a sound level of a voice of the user, and performing, based on the own voice sound level, an operation with respect to the adjustment.

By using systems and methods such as those described herein, it may be possible to adaptively and continually improve target signal separation algorithms applied by the hearing device in a manner specific to the user of the hearing device and based on real-world environments and situations encountered by the user. For example, the hearing device may perform an adjustment to a target signal separation algorithm and use the own voice sound level as a feedback input to evaluate an efficacy of the adjustment. Due to the Lombard effect, the user may subconsciously raise or lower his or her voice level based on a perceived noise level. Thus, the own voice level may be used as an unbiased proxy for determining whether an adjustment to a target signal separation algorithm results in an audio signal that is more or less noisy as perceived by the user. Therefore, based on the own voice level, the hearing device may perform various operations with respect to the adjustment, such as retaining the adjustment, rejecting the adjustment, modifying the adjustment, further adjusting the target signal separation algorithm based on the adjustment, etc.

In this manner, the hearing device may adaptively improve the target signal separation algorithms themselves, not just an application or a selection of target signal separation algorithms applied to the input audio signal. Such improved target signal separation algorithms may improve and operation of a hearing device and hearing performance for the user. Other benefits of the systems and methods described herein will be made apparent herein.

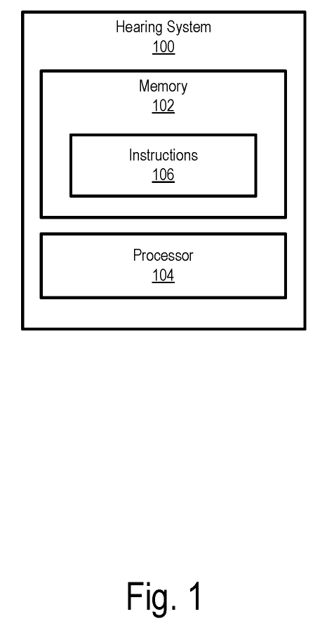

FIG. 1 illustrates an exemplary hearing system 100 (“system 100”) that may be implemented according to principles described herein. As shown, system bmay include, without limitation, a memory 102 and a processor 104 selectively and communicatively coupled to one another. Memory 102 and processor 104 may each include or be implemented by hardware and/or software components (e.g., processors, memories, communication interfaces, instructions stored in memory for execution by the processors, etc.). In some examples, memory 102 and/or processor 104 may be implemented by any suitable computing device such as described herein. In other examples, memory 102 and/or processor 104 may be distributed between multiple devices and/or multiple locations as may serve a particular implementation. Illustrative implementations of system 100 are described herein.

Memory 102 may maintain (e.g., store) executable data used by processor 104 to perform any of the operations described herein. For example, memory 102 may store instructions 106 that may be executed by processor 104 to perform any of the operations described herein. Instructions 106 may be implemented by any suitable application, software, code, and/or other executable data instance.

Memory 102 may also maintain any data received, generated, managed, used, and/or transmitted by processor 104. Memory 102 may store any other suitable data as may serve a particular implementation. For example, memory 102 may store hearing loss profile data, user preference data, setting data, acoustic parameter data, machine learning data, input sound classification data, hearing performance data, graphical user interface content, movement classification data, model data, sensor data, and/or any other suitable data.

Processor 104 may be configured to perform (e.g., execute instructions 106 stored in memory 102 to perform) various processing operations associated with adaptive improvement for target signal separation. These and other operations that may be performed by processor 104 are described herein.

As used herein, a “hearing device” may be implemented by any device or combination of devices configured to provide or enhance hearing to a user. For example, a hearing device may be implemented by a hearing aid configured to amplify audio content to a recipient, a sound processor included in a stimulation system configured to apply electrical and acoustic stimulation to a recipient, or any other suitable hearing prosthesis. In some examples, a hearing device may be implemented by a behind-the-ear (“BTE”) housing configured to be worn behind an ear of a user. In some examples, a hearing device may be implemented by an in-the-ear (“ITE”) component configured to at least partially be inserted within an ear canal of a user. In some examples, a hearing device may include a combination of an ITE component, a BTE housing, and/or any other suitable component.

In certain examples, hearing devices such as those described herein may be implemented as part of a binaural hearing system. Such a binaural hearing system may include a first hearing device associated with a first ear of a user and a second hearing device associated with a second ear of a user. In such examples, the hearing devices may each be implemented by any type of hearing device configured to provide or enhance hearing to a user of a binaural hearing system. In some examples, the hearing devices in a binaural system may be of the same type. For example, the hearing devices may each be hearing aid devices. In certain alternative examples, the hearing devices may be of a different type.

In some examples, a hearing device may additionally or alternatively include earbuds, headphones, hearables (e.g., smart headphones), and/or any other suitable device that may be used to facilitate a user perceiving sound in an environment. In such examples, the user may correspond to either a hearing-impaired user or a non-hearing-impaired user.

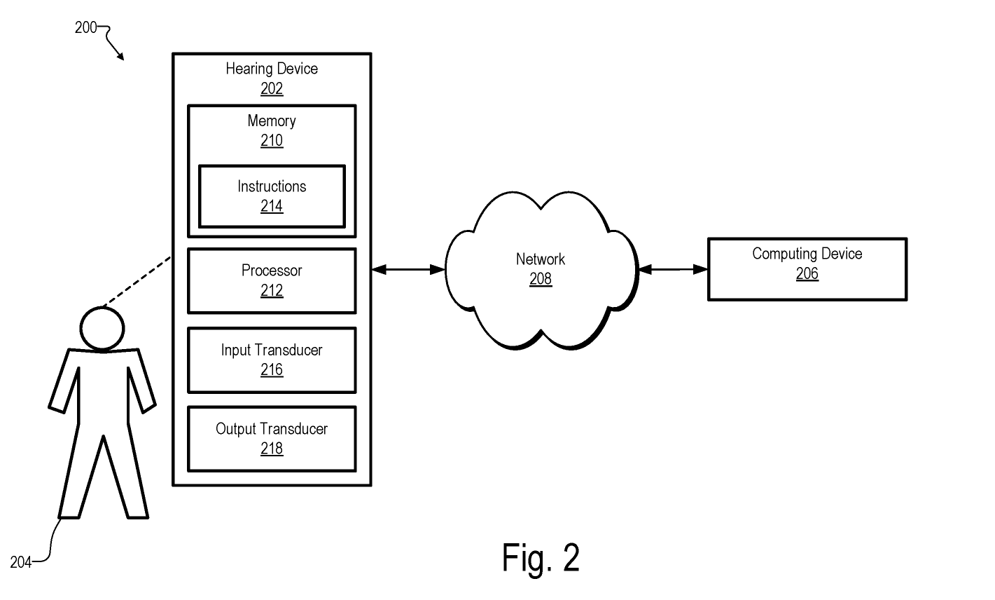

System 100 may be implemented in any suitable manner. For example, system 100 may be implemented by a hearing device and/or a computing device that is communicatively coupled in any suitable manner to the hearing device. To illustrate an example, FIG. 2 shows an exemplary implementation 200 in which system 100 may be provided in certain implementations. As shown in FIG. 2, implementation 200 includes a hearing device 202 that is associated with a user 204 and that is communicatively coupled to a computing device 206 by way of a network 208.

Hearing device 202 may correspond to any suitable type of hearing device such as described herein. Hearing device 202 may include, without limitation, a memory 210 and a processor 212 selectively and communicatively coupled to one another. Memory 210 and processor 212 may each include or be implemented by hardware and/or software components (e.g., processors, memories, communication interfaces, instructions stored in memory for execution by the processors, etc.). In some examples, memory 210 and processor 212 may be housed within or form part of a BTE housing. In some examples, memory 210 and processor 212 may be located separately from a BTE housing (e.g., in an ITE component). In some alternative examples, memory 210 and processor 212 may be distributed between multiple devices (e.g., multiple hearing devices in a binaural hearing system) and/or multiple locations as may serve a particular implementation.

Memory 210 may maintain (e.g., store) executable data used by processor 212 to perform any of the operations associated with hearing device 202. For example, memory 210 may store instructions 214 that may be executed by processor 212 to perform any of the operations associated with hearing device 202 assisting a user in hearing. Instructions 214 may be implemented by any suitable application, software, code, and/or other executable data instance.

Memory 210 may also maintain any data received, generated, managed, used, and/or transmitted by processor 212. For example, memory 210 may maintain any suitable data associated with a hearing loss profile of a user, input sound classifications, sound processing patterns, machine learning algorithms, and/or hearing device function data. Memory 210 may maintain additional or alternative data in other implementations.

Processor 212 is configured to perform any suitable processing operation that may be associated with hearing device 202. For example, when hearing device 202 is implemented by a hearing aid device, such processing operations may include monitoring ambient sound and/or representing sound to user 204 via an in-ear receiver. Processor 212 may be implemented by any suitable combination of hardware and software. In certain examples, processor 212 may correspond to or otherwise include one or more deep neural network (“DNN”) chips configured to perform any suitable machine learning operation such as described herein.

Hearing device 202 may further include an input transducer 216 and an output transducer 218. Hearing device 202 may include additional or alternative components as may serve a particular implementation.

Input transducer 216 may include one or more electroacoustic transducers, e.g., one or more microphones and/or one or more microphone arrays. The one or more microphones may be implemented by one or more suitable audio detection devices configured to detect audio data representative of one or more audio signals presented to a user of hearing device 202. The one or more audio signals may include, for example, audio content (e.g., music, speech, noise, etc.) generated by one or more audio sources included in an environment of the user (e.g., environmental audio/sound). Each microphone may be included in or communicatively coupled to hearing device 202 in any suitable manner.

Additionally or alternatively, input transducer 216 may include a radio frequency (RF) receiver configured to receive RF signals including audio data representative of one or more audio signals presented to the user of hearing device 202. For instance, the RF signals may be received in accordance with a Bluetooth^{TM} protocol and/or by a mobile phone network such as 4G or 5G and/or by any other type of RF communication such as, for example, data communication via an internet connection and/or data communication at a frequency in a GHz range. The audio signal may include, for example, a phone call signal and/or a streaming signal which may be received while delivered from an audio provider, such as a phone call signal provider and/or a streaming media provider and/or may comprise a signal transmitted from a source device, e.g., a smartphone. Each RF receiver may be included in hearing device 202 and/or communicatively coupled to hearing device 202 in any suitable manner.

Output transducer 218 may be implemented by any suitable audio output device, for instance a loudspeaker of a hearing device.

User 204 may be any individual that is a user of a hearing device. Computing device 206 may include or be implemented by any suitable hardware and/or software components (e.g., processors, memories, communication interfaces, instructions stored in memory for execution by the processors, etc.) and may include any combination of computing devices as may serve a particular implementation. In some examples, computing device 206 may be implemented by a mobile phone, a mobile computing device, a tablet computer, a laptop computer, a desktop computer, a server or server system, and/or any other suitable computing device and/or system that may be configured to improve a hearing performance level of the hearing device. In such examples, computing device 206 may be configured to perform any suitable operations such as those described herein.

Network 208 may include, but is not limited to, one or more wireless networks (Wi-Fi networks), wireless communication networks, mobile telephone networks (e.g., cellular telephone networks), mobile phone data networks, broadband networks, narrowband networks, the Internet, local area networks, wide area networks, and any other networks capable of carrying data and/or communications signals between hearing device 202 and computing device 206. In certain examples, network 208 may be implemented by a Bluetooth protocol (e.g., Bluetooth Classic, Bluetooth Low Energy (“LE”), etc.) and/or any other suitable communication protocol to facilitate communications between hearing device 202 and computing device 206. Communications between hearing device 202, computing device 206, and any other device/system may be transported using any one of the above-listed networks, or any combination or sub-combination of the above-listed networks.

System 100 may be implemented by computing device 206 or hearing device 202. Alternatively, system 100 may be distributed across computing device 206 and hearing device 202, or distributed across computing device 206, hearing device 202, and/or any other suitable computing system/device.

Hearing device 202 may be configured to be optimized for user 204 by adaptively improving one or more target signal separation algorithms of hearing device 202 based on feedback determined from user 204.

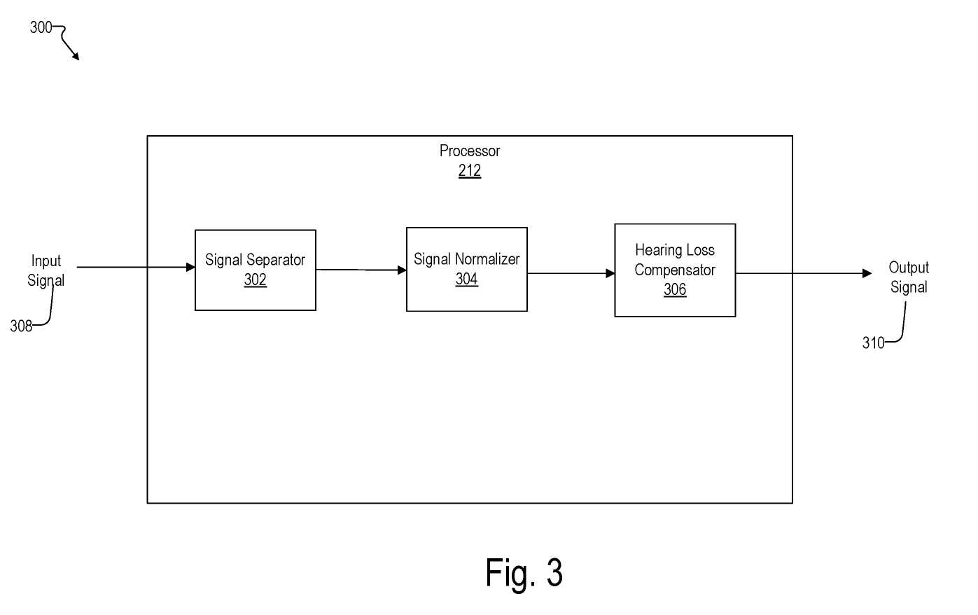

For example, FIG. 3 illustrates an exemplary configuration 300 that shows an example implementation of processor 212 of hearing device 202. Processor 212 may include various components that perform various sound processing algorithms and/or functions of one or more sound processing algorithms. For example, processor 212 may include a signal separator 302, a signal normalizer 304, and a hearing loss compensator 306. While shown as separate components in configuration 300, these components may be portions of a same component, additional components, etc. to perform any suitable sound processing operations.

For example, signal separator 302 may be configured to receive an input signal 308, which may include various audio signals. For instance, input signal 308 may include a target signal along with one or more noise signals. The target signal may be any audio signal that may be of interest or a focus of listening by user 204, such as speech, music, audio from a particular device, etc. Noise may include any non-target signal, which may include environmental audio (e.g., traffic sounds, background conversation, background music, wind, etc.) or any other such extraneous sound. Signal separator 302 may be configured to separate the target signal from the noise in input signal 308.

Signal separator 302 may perform various target signal separation algorithms that work to separate the target signal. For example, signal separator 302 may apply noise reduction algorithms, which may include any suitable algorithms for reducing noise, such as an active noise control algorithm, a static noise canceling algorithm (e.g., for particular types of noise), dereverberation algorithms, etc. Additionally or alternatively, the noise reduction algorithm may include a machine learning algorithm, such as a deep neural network (DNN) configured for denoising. Additionally or alternatively, signal separator 302 may apply target signal enhancement algorithms, which may include any suitable algorithms for enhancing the target signal. Example target signal enhancement algorithms may include target signal detection algorithms (e.g., speech detection algorithms, music detection algorithms, etc.), spatial enhancement algorithms (e.g., beamforming or any other type of directional signal pickup algorithms), dereverberation algorithms, etc. Additionally or alternatively, the target signal enhancement algorithms may also include a machine learning algorithm, such as a DNN, which may be the same DNN as the noise reduction algorithm (e.g., a DNN configured to both separate/enhance the target signal and reduce noise) or a separate DNN.

Signal normalizer 304 may be configured to normalize an input audio signal, which may be a normalization of the audio signal independent of hearing capabilities and/or a hearing profile of user 204. For instance, as shown in exemplary configuration 300, signal normalizer 304 may receive the input audio signal from signal separator 302, which may be processed by signal separator 302 into two separate audio streams representing the target signal and the noise signal. Additionally or alternatively, signal separator 302 may provide a combined signal, such as with the target signal enhanced relative to the noise. Signal normalizer 304 may receive the one or more audio signals and process the audio to normalize the audio (e.g., adjusting the loudness to a standard level, etc.). Signal normalizer 304 may normalize the audio in any suitable manner, such as using a gain model, system steering, etc.

Hearing loss compensator 306 may be configured to process the audio based on an individualized fitting of hearing device 202 to user 204. For example, hearing loss compensator 306 may process the audio tailored to a hearing loss profile of user 204, amplifying and/or otherwise processing portions or all of the audio signal in measures specific to user 204 to improve hearing performance. Further, hearing loss compensator 306 may apply different sound processing programs configured for different situations, environments, target signals, etc. Additionally or alternatively, hearing loss compensator 306 may apply any suitable fine tuning sound processing algorithms. Hearing loss compensator 306 may output an output signal 310 that represents the audio as processed by sound processing algorithms of processor 212. Output signal 310 may be provided to user 204, such as via output transducer 218 so that user 204 may hear the processed audio signal.

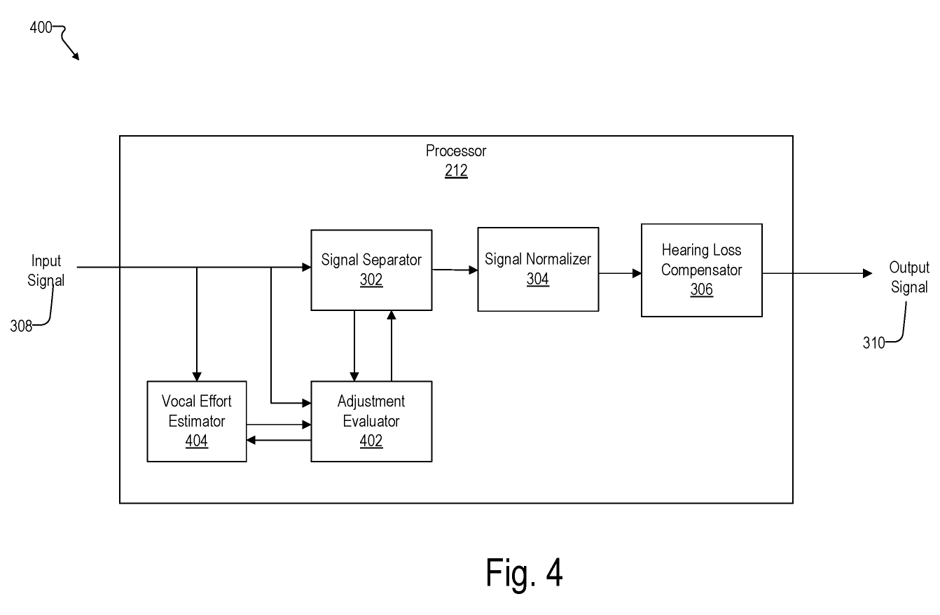

Processor 212 may be further configured to adaptively improve the target signal separation algorithms applied to input signal 308 to generate output signal 310 in a manner personalized to user 204. For example, FIG. 4 illustrates an exemplary configuration 400 that shows processor 212 with additional components, including an adjustment evaluator 402 and a vocal effort estimator 404. Processor 212 (or any suitable component of processor 212) may perform an adjustment to one or more of the target signal separation algorithms applied to input signal 308 and use adjustment evaluator 402 and vocal effort estimator 404 to evaluate the adjustment. Based on the evaluation, processor 212 (e.g., adjustment evaluator 402 and/or any other component(s) of processor 212) may perform an operation with respect to the adjustment. While exemplary configuration 400 shows an adjustment applied to a sound processing algorithm of signal separator 302 the adjustment may be applied to any suitable sound processing algorithm or algorithms, including algorithms of signal normalizer 304, hearing loss compensator 306, etc.

For example, processor 212 may perform an adjustment to a target signal separation algorithm. In some examples, the adjustment may be to the target signal separation algorithm itself (and/or a parameter and/or an aspect of the target signal separation algorithm), not just an adjustment to an application of the target signal separation algorithm or algorithms. For instance, while the adjustment may include a change in which target signal separation algorithm and/or combination of target signal separation algorithms are applied to the audio signal, the adjustment may additionally or alternatively include changes to one or more parameters of one or more of the algorithms and how the target signal separation algorithms are processing the audio signal.

Adjustment evaluator 402 may evaluate the adjustment to determine whether the adjustment improves hearing performance for user 204. Adjustment evaluator 402 may evaluate the adjustment in any suitable manner. For example, adjustment evaluator 402 may receive an input from vocal effort estimator 404, which may be configured to determine how much effort user 204 is making to speak. Adjustment evaluator 402 may use the vocal effort of user 204 as a proxy for determining whether the adjustment made to the target signal separation algorithm is effective. Based on the Lombard effect, user 204 may subconsciously raise or lower his or her voice level (e.g., a pitch and/or an intensity of the voice) based on a perceived noise level, which may provide an unbiased response to an efficacy of the adjustment made to the target signal separation algorithm. Thus, if the adjustment made to the target signal separation algorithm results in user 204 perceiving less noise in output signal 310, the voice level of user 204 may lower as user 204 subconsciously speaks softer to match the lowered perceived noise level. Conversely, if the adjustment made to the target signal separation algorithm results in user 204 perceiving more noise in output signal 310, the own voice level may rise as user 204 subconsciously speaks louder to match the raised perceived noise level. In this manner, adjustment evaluator 402 may use the voice level of user 204 as a feedback input to adaptively adjust and improve the target signal separation algorithms being applied to input signal 308.

Such feedback may provide data in real-time (or near real-time) that may be used to assess effectiveness of adjustments made to the target signal separation algorithms in real-world (and/or controlled) settings. Further, the feedback may be specific and personal to user 204 and indicate how user 204 may be perceiving the target signal compared to the noise in output signal 310. For instance, while the target signal separation algorithms may be able to quantify audio levels within the audio signal that correspond to different portions of the audio signal (including target signal, noise signal and/or portions of each), such quantified evaluations may not directly correspond to noise as perceived by users in general and specifically by user 204 with a particular hearing profile. Further, a level of perceived noise may depend on various other factors, such as a type of target signal, a type of background noise, a type of target signal relative to a type of background noise, coupling of hearing device 202, etc. Thus, based on the vocal effort of user 204 in response to different adjustments to the target signal separation algorithms that result in different audio signals, processor 212 may further learn what types of target signal separation and/or what effects of the target signal separation may correspond to better signal-to-noise ratio for user 204 in specific environments.

Accordingly, adjustment evaluator 402 may perform operations with respect to adjustments based on vocal effort estimator 404 (which may be based on the own voice sound level) of user 204. For example, vocal effort estimator 404 may determine that based on performing a particular adjustment to the target signal separation algorithm (e.g., signal separator 302, adjusting a parameter of a target signal separation algorithm, etc.), that the own voice sound level is lower than a threshold sound level. Vocal effort estimator 404 may make such a determination in any suitable manner, such as comparing the own voice sound level to a predetermined threshold sound level, and/or comparing a difference in the own voice sound level subsequent to the adjustment with the own voice sound level prior to the adjustment, or any other comparison, examples of which are further described herein.

Based on determining that the own voice sound level is lower than the threshold sound level, adjustment evaluator 402 may determine that the particular adjustment to the sound processing algorithm is effective, and therefore retain the adjustment to the target signal separation algorithm. As used herein, retaining an adjustment to a target signal separation algorithm may include changing or modifying the target signal separation algorithm to incorporate the adjustment. Further, based on determining that the particular adjustment was effective, processor 212 may further adjust the target signal separation algorithm based on the adjustment. For example, the further adjustment may be an increase in the particular adjustment. For instance, a particular adjustment may include an increase (or decrease) in a value of a parameter of the target signal separation algorithm that results in an increase in signal-to-noise ratio for a particular frequency range of the audio signal. The evaluation of the adjustment based on the own voice sound level being lower than the threshold sound level may indicate that the adjustment is an effective change to the target signal separation algorithm. Consequently, processor 212 may perform a further adjustment, such as a further increase (or decrease) in the value of the parameter that was adjusted.

Conversely, vocal effort estimator 404 may determine that, based on the initial adjustment to the target signal separation algorithm, the own voice sound level is higher than a threshold sound level. For example, vocal effort estimator 404 may determine that the own voice sound level is higher subsequent to the adjustment than prior to the adjustment. Additionally or alternatively, vocal effort estimator 404 may compare the own voice sound level to a predetermined threshold sound level, an expected sound level, a sound level relative to an environmental sound level, a sound level relative to a baseline own voice sound level for user 204, etc. Based on such a determination, adjustment evaluator 402 may determine that the adjustment is not effective and/or suboptimal, and consequently, reject the adjustment and revert the target signal separation algorithm to a state prior to the adjustment. Additionally or alternatively, adjustment evaluator 402 may modify the adjustment. For example, adjustment evaluator 402 may modify the adjustment by changing a parameter and/or a value of the adjustment. For instance, for such adjustments where there may be an inverse, the modification may include an inversion of the adjustment and/or an adjustment that results in an opposite effect to the audio signal. Adjustment evaluator 402 may further evaluate such a modification to the adjustment as a further adjustment and perform an operation with respect to the further adjustment.

In some examples, the target signal separation algorithm may include a machine learning algorithm (e.g., the DNN configured to separate speech from noise, any other machine-learning-based target signal separation algorithm and/or any other suitable machine learning algorithm). For such target signal separation algorithms, an adjustment to the target signal separation algorithm may include an adjusting of a parameter of the machine learning algorithm. Such adjusting of a machine learning algorithm parameter may include any suitable parameter of the machine learning algorithm that may be changed to produce a different processing of an input audio signal to an output audio signal. In some examples, the machine learning algorithm may initiate the adjustment in any suitable manner. By receiving feedback on an efficacy of such adjustments, the machine learning algorithm may learn how to improve itself and/or other aspects of the target signal separation algorithms. Further, as different target signal separation algorithms may be improved by different adjustments (e.g., based on a type of background noise, different parameters and/or parameter values may affect the target signal separation algorithm differently), each target signal separation algorithm may be adaptively improved as user 204 encounters environments and situations for applying each of the target signal separation algorithms and/or specific combinations of target signal separation algorithms.

Further, the feedback may include a magnitude of the efficacy of the adjustment, such as based on a magnitude in a difference in the own voice sound level. The machine learning algorithm may include such measures of efficacy of adjustments into consideration in applying subsequent adjustments and/or balancing such adjustments when adjustments may come with tradeoffs, such as power consumption considerations, introducing artifacts into the audio signal, and/or reducing noise to an extent that user 204 speaks too softly relative to an environmental noise level. For instance, in some examples, an adjustment may include turning off a particular target signal separation algorithm, such as based on determining that a magnitude of an effect of the target signal separation algorithm is below a threshold level, where turning off the target signal separation algorithm (e.g., a DNN) may conserve power. Such adjustments may further take into consideration other relevant characteristics and/or parameters of hearing device 202, such as a remaining power level of hearing device 202, etc.

While exemplary configuration 400 shows adjustment evaluator 402 and vocal effort estimator 404 configured to evaluate adjustments made to target signal separation algorithms as components of processor 212, in some configurations, such components may be included in other components of processor 212, implemented as components in other computing devices (e.g., one or more cloud computing devices, a mobile phone, any other suitable computing device configured to communicate with hearing device 202, etc.), and/or any suitable combination of such processors and computing devices.

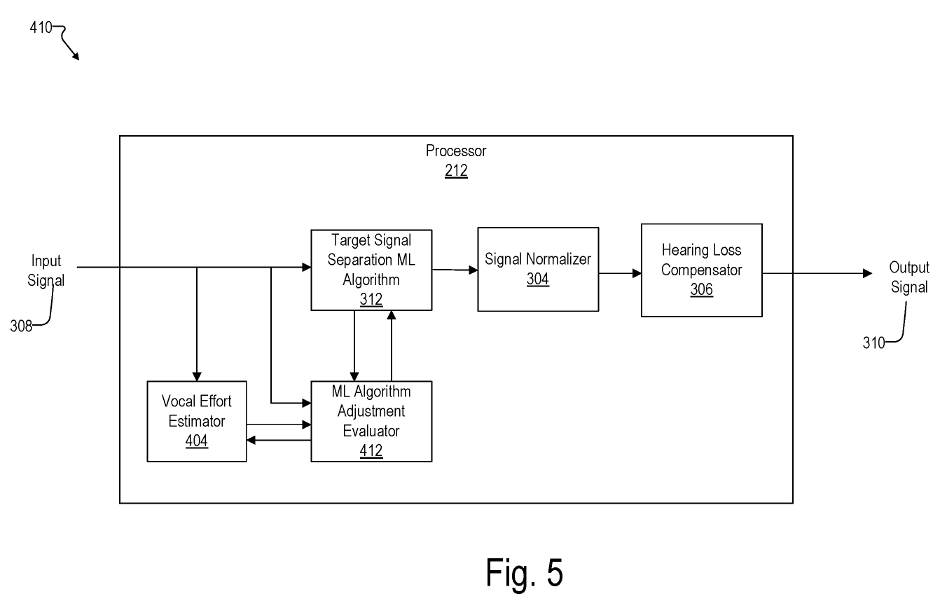

FIG. 5 illustrates another exemplary configuration 410 in which signal separator 302 is implemented as a machine learning (ML) algorithm 312 for separating a target signal from input signal 308. For example, machine learning algorithm 312 may implemented as a DNN which may be employed to enhance speech intelligibility by separating speech signals from background noise. Such a DNN may also be referred to as a denoising DNN. For example, the target signal may be speech, music, or other specific sounds which may occur in the environment of user 204.

For example, ML algorithm 312 may be configured to separate speech from input signal 308 representative of a general speech in the environment of user 204, which may also be referred to as an environmental speech. The separated speech signal may then include speech of multiple speakers speaking at the same time, or a single speaker when nobody else is speaking. As another example, ML algorithm 312 may be configured to separate an individual speech from input signal 308, e.g., one or more speech signals representative of speech of different persons, in particular one or more persons known to the user such as a significant other, friend, acquaintance or a previous conversation partner. ML algorithm 312 may be trained to provide for such a separation of environmental speech and/or individual speech from input signal 308.

To illustrate, ML algorithms for speech separation, in particular DNNs, are typically trained using large datasets of audio signals containing both speech and various types of noise. The training process involves adjusting the DNN’s parameters to optimize its ability to separate speech from interference. Conventional training methods rely on supervised learning, where a labeled dataset provides reference signals indicating the ideal separation of speech and noise. Those methods, however, are computationally expensive and highly dependent on the quality and diversity of training data. A major challenge in the training is the complexity of determining whether the DNN is progressing effectively. The training process involves iterative self-adjustments based on computed errors between expected and actual outputs. However, these adjustments can sometimes lead to undesirable deviations, causing the DNN to converge to suboptimal performance or even degrade its speech separation ability. Traditional performance evaluation metrics, such as a signal-to-noise ratio improvement, provide a general assessment but fail to capture how well the DNN adapts to individual users or specific listening conditions. This results in an inefficient training process, where progress is often unclear and adjustments may be counterproductive.

Configuration 410 aims to mitigate this problem, wherein adjustment evaluator 402 is employed as a ML algorithm adjustment evaluator 412. In particular, during a training of ML algorithm 312, in which the parameter adjustments of the ML algorithm are self-initiated by the ML algorithm, ML algorithm adjustment evaluator 412 can provide for a mechanism that evaluates the effectiveness of the self-adjustments based on the own voice sound level. The evaluated effectiveness can then be fed back to ML algorithm 312 based on which ML algorithm 312 may either retain or reject the adjustment. In this regard, the feedback provided by ML algorithm adjustment evaluator 412 may be regarded as a power function that indicates whether ML algorithm 312 is making progress or whether a given self-adjustment negatively impacts its performance.

To illustrate, when a given self-adjustment of ML algorithm 312 leads to a degradation of output signal 310, a perceived increase in background noise or other degradation of output signal 310 may provoke user 204 to raise his own-voice above the threshold of the own-voice sound level. Such an (often unconscious) behavior of user 204 can be caused by an (also subconscious) impression that the increase in background noise makes a speech of a conversation partner harder to perceive or comprehend thus requiring an adaption of the own-voice to compensate for the degradation when talking to the conversation partner. In such a case, the adjustment of ML algorithm 312 is rather ineffective and can therefore be rejected. On the other hand, when user’s 204 own-voice sound level is below threshold, it indicates that output signal 310 can be well perceived so that the self-adjustment of ML algorithm 312 can be retained.

Accordingly, configuration 410 may be advantageously employed during a training of ML algorithm 312. The self-adjusted parameter may be retained or rejected based on the own voice sound level so as to control, e.g., supervise, the training with regard to a quality of the adjustment. In particular, the quality of the adjustment may indicate an effectiveness of the adjustment with regard to an enhancement of the separated target signal and/or a removing of noise from the target signal. In this regard, the own-voice sound level may then be representative of a performance of ML algorithm 312. E.g., such a performance metric derived from the own-voice sound level may be representative of a power function for the training of ML algorithm 312.

For example, the training of ML algorithm 312 may be performed before the deployment of ML algorithm 312 by user 204 in hearing device 202, e.g., in an initial training so as to produce ML algorithm 312 from scratch or based on a pre-existing model. Input signal 308 may then be representative of predefined training data obtained for the specific purpose of the training of ML algorithm 312.

As another example, the training of ML algorithm 312 may be performed so as to refine ML algorithm 312 after the initial training, e.g., during actual use of ML algorithm 312 when implemented in hearing device 202. Input signal 308 may then be representative of any type of audio signals occurring in the acoustic environment of user 204. ML algorithm 312 may thus be finetuned based on the performance metric derived by ML algorithm adjustment evaluator 412 from the user’s own-voice, e.g., during daily activities of user 204. Self-adjustments performed by ML algorithm 312 may thus be individualized in that they could enhance the performance relative to the user’s specific needs. Further, even when pre-trained ML algorithm 312 performs well under the controlled conditions of the initial training, it may struggle when exposed to unpredictable noise types or speech patterns that may be encountered in daily usage by user 204. A refining of ML algorithm 312 during the wearing of hearing device 202 could remedy this issue.

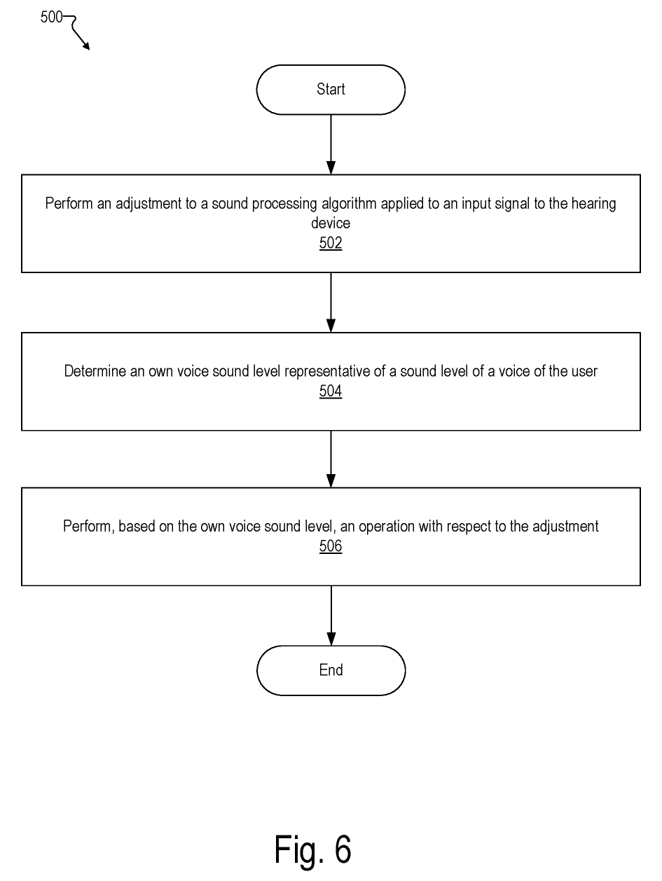

FIG. 6 illustrates an exemplary method 500 for adaptive improvement for target signal separation by a hearing device according to principles described herein. While FIG. 6 illustrates exemplary operations according to one embodiment, other embodiments may omit, add to, reorder, and/or modify any of the operations shown in FIG. 6. One or more of the operations shown in FIG. 6 may be performed by a hearing device such as hearing device 202, processor 212 of hearing device 202, a computing device such as computing device 206, an additional computing device communicatively coupled to computing device 206 and/or hearing device 202, any components included therein, and/or any combination or implementation thereof.

At operation 502, a processor associated with a hearing device worn by a user may perform an adjustment to a sound processing algorithm applied to an input signal to the hearing device. Operation 502 may be performed in any of the ways described herein.

At operation 504, the processor may determine an own voice sound level representative of a sound level of a voice of the user. Operation 504 may be performed in any of the ways described herein.

At operation 506, the processor may perform, based on the own voice sound level, an operation with respect to the adjustment. Operation 506 may be performed in any of the ways described herein.

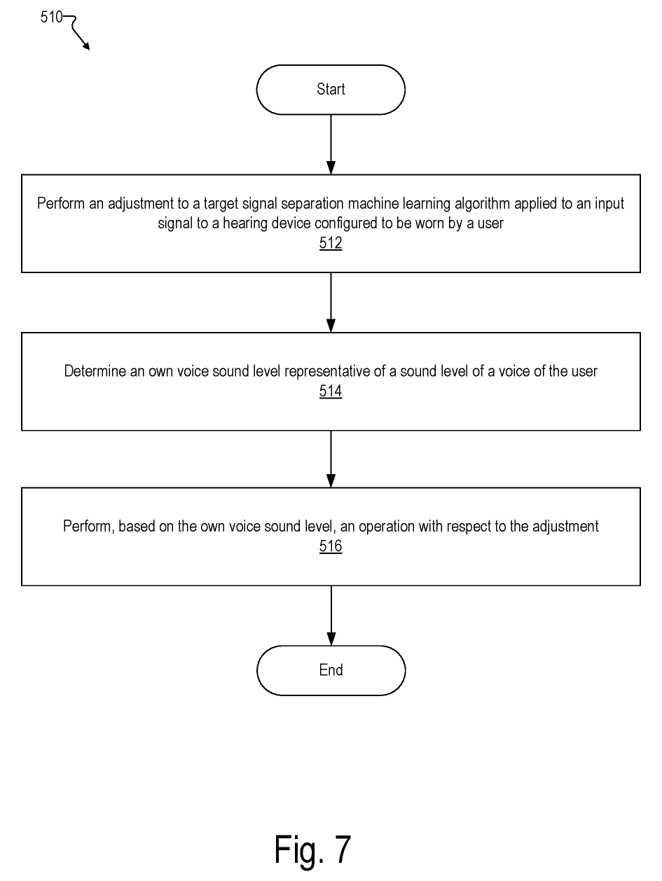

FIG. 7 illustrates an exemplary method 510 for training a target signal separation machine learning algorithm according to principles described herein. While FIG. 7 illustrates exemplary operations according to one embodiment, other embodiments may omit, add to, reorder, and/or modify any of the operations shown in FIG. 7. One or more of the operations shown in FIG. 7 may be performed by a hearing device such as hearing device 202, processor 212 of hearing device 202, a computing device such as computing device 206 (e.g., a computing device external to hearing device 202), an additional computing device communicatively coupled to computing device 206 and/or hearing device 202, any components included therein, and/or any combination or implementation thereof.

At operation 512, a processor may perform an adjustment to a target signal separation machine learning algorithm applied to an input signal to a hearing device configured to be worn by a user. Operation 512 may be performed in any of the ways described herein.

At operation 514, the processor may determine an own voice sound level representative of a sound level of a voice of the user. Operation 514 may be performed in any of the ways described herein.

At operation 516, the processor may perform, based on the own voice sound level, an operation with respect to the adjustment. Operation 516 may be performed in any of the ways described herein.

In some examples, a computer program product embodied in a non-transitory computer-readable storage medium may be provided. In such examples, the non-transitory computer-readable storage medium may store computer-readable instructions in accordance with the principles described herein. The instructions, when executed by a processor of a computing device, may direct the processor and/or computing device to perform one or more operations, including one or more of the operations described herein. Such instructions may be stored and/or transmitted using any of a variety of known computer-readable media.

A non-transitory computer-readable medium as referred to herein may include any non-transitory storage medium that participates in providing data (e.g., instructions) that may be read and/or executed by a computing device (e.g., by a processor of a computing device). For example, a non-transitory computer-readable medium may include, but is not limited to, any combination of non-volatile storage media and/or volatile storage media. Exemplary non-volatile storage media include, but are not limited to, read-only memory, flash memory, a solid-state drive, a magnetic storage device (e.g., a hard disk, a floppy disk, magnetic tape, etc.), ferroelectric random-access memory (“RAM”), and an optical disc (e.g., a compact disc, a digital video disc, a Blu-ray disc, etc.). Exemplary volatile storage media include, but are not limited to, RAM (e.g., dynamic RAM).

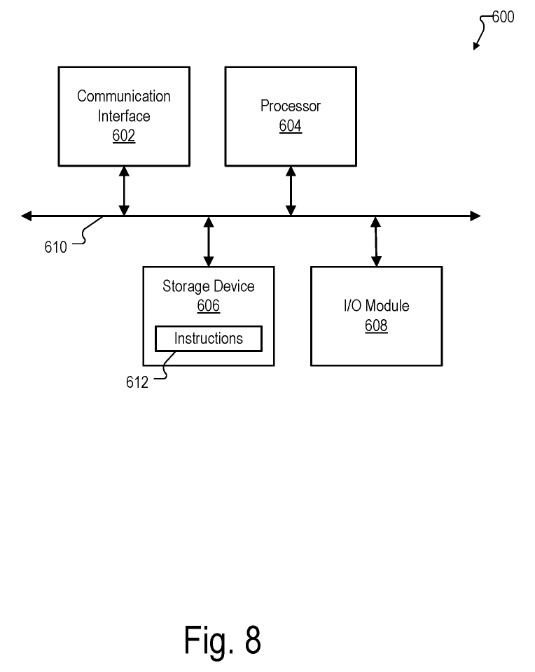

FIG. 8 illustrates an exemplary computing device 600 that may be specifically configured to perform one or more of the processes described herein. As shown in FIG. 8, computing device 600 may include a communication interface 602, a processor 604, a storage device 606, and an input/output (“I/O”) module 608 communicatively connected one to another via a communication infrastructure 610. While an exemplary computing device 600 is shown in FIG. 8, the components illustrated in FIG. 8 are not intended to be limiting. Additional or alternative components may be used in other embodiments. Components of computing device 600 shown in FIG. 8 will now be described in additional detail.

Communication interface 602 may be configured to communicate with one or more computing devices. Examples of communication interface 602 include, without limitation, a wired network interface (such as a network interface card), a wireless network interface (such as a wireless network interface card), a modem, an audio/video connection, and any other suitable interface.

Processor 604 generally represents any type or form of processing unit capable of processing data and/or interpreting, executing, and/or directing execution of one or more of the instructions, processes, and/or operations described herein. Processor 604 may perform operations by executing computer-executable instructions 612 (e.g., an application, software, code, and/or other executable data instance) stored in storage device 606.

Storage device 606 may include one or more data storage media, devices, or configurations and may employ any type, form, and combination of data storage media and/or device. For example, storage device 606 may include, but is not limited to, any combination of the non-volatile media and/or volatile media described herein. Electronic data, including data described herein, may be temporarily and/or permanently stored in storage device 606. For example, data representative of computer-executable instructions 612 configured to direct processor 604 to perform any of the operations described herein may be stored within storage device 606. In some examples, data may be arranged in one or more databases residing within storage device 606.

I/O module 608 may include one or more I/O modules configured to receive user input and provide user output. I/O module 608 may include any hardware, firmware, software, or combination thereof supportive of input and output capabilities. For example, I/O module 608 may include hardware and/or software for capturing user input, including, but not limited to, a keyboard or keypad, a touchscreen component (e.g., touchscreen display), a receiver (e.g., an RF or infrared receiver), motion sensors, and/or one or more input buttons.

I/O module 608 may include one or more devices for presenting output to a user, including, but not limited to, a graphics engine, a display (e.g., a display screen), one or more output drivers (e.g., display drivers), one or more audio speakers, and one or more audio drivers. In certain embodiments, I/O module 608 is configured to provide graphical data to a display for presentation to a user. The graphical data may be representative of one or more graphical user interfaces and/or any other graphical content as may serve a particular implementation.

In some examples, any of the systems, hearing devices, computing devices, and/or other components described herein may be implemented by computing device 600. For example, memory 102 and/or memory 210 may be implemented by storage device 606, and processor 104 and/or processor 212 may be implemented by processor 604.

In the preceding description, various exemplary embodiments have been described with reference to the accompanying drawings. It will, however, be evident that various modifications and changes may be made thereto, and additional embodiments may be implemented, without departing from the scope of the invention as set forth in the claims that follow. For example, certain features of one embodiment described herein may be combined with or substituted for features of another embodiment described herein. The description and drawings are accordingly to be regarded in an illustrative rather than a restrictive sense.

What is claimed is:

1. A method comprising:
performing, by a processor associated with a hearing device worn by a user, an adjustment to a target signal separation algorithm applied to an input signal to the hearing device;
determining, by the processor, an own voice sound level representative of a sound level of a voice of the user; and
performing, by the processor and based on the own voice sound level, an operation with respect to the adjustment.

2. The method of claim 1, wherein the performing the operation with respect to the adjustment comprises:
determining, based on the performing the adjustment to the target signal separation algorithm, that the own voice sound level is lower than a threshold sound level; and
retaining, based on the determining that the own voice sound level is lower than the threshold sound level, the adjustment to the target signal separation algorithm.

3. The method of claim 2, further comprising performing, based on the determining that the own voice sound level is lower than the threshold sound level, a further adjustment based on the adjustment to the target signal separation algorithm.

4. The method of claim 1, wherein the performing the operation with respect to the adjustment comprises:
determining that the own voice sound level is higher than a threshold sound level; and
rejecting, based on the determining that the own voice sound level is higher than the threshold sound level, the adjustment to the target signal separation algorithm.

5. The method of claim 1, wherein the performing the operation with respect to the adjustment comprises:
determining that the own voice sound level is higher than a threshold sound level; and
modifying, based on the determining that the own voice sound level is higher than the threshold sound level, the adjustment to the target signal separation algorithm.

6. The method of claim 1, wherein the target signal separation algorithm comprises a noise reduction algorithm.

7. The method of claim 1, wherein the target signal separation algorithm comprises a speech separation algorithm.

8. The method of claim 1, wherein the target signal separation algorithm comprises a machine learning algorithm.

9. The method of claim 8, wherein the machine learning algorithm comprises a deep neural network (DNN) configured to separate speech from noise.

10. The method of claim 8, wherein the performing the adjustment comprises adjusting a parameter of the machine learning algorithm, the adjusting initiated by the machine learning algorithm.

11. The method of claim 10, wherein the adjusting the parameter of the machine learning algorithm is initiated during a training of the machine learning algorithm.

12. The method of claim 11, wherein the performing the operation with respect to the adjustment comprises retaining or rejecting the adjusting the parameter based on the own voice sound level so as to control the training with regard to a quality of the adjustment.

13. The method of claim 11, wherein the own voice sound level is representative of a performance metric of the machine learning algorithm.

14. A method of training a target signal separation machine learning algorithm, the method comprising:
performing, by a processor, an adjustment to the target signal separation machine learning algorithm applied to an input signal to a hearing device configured to be worn by a user;
determining, by the processor, an own voice sound level representative of a sound level of a voice of the user; and
performing, by the processor and based on the own voice sound level, an operation with respect to the adjustment.

15. The method of claim 14, wherein the performing the operation with respect to the adjustment comprises:
determining, based on the performing the adjustment to the target signal separation machine learning algorithm, that the own voice sound level is lower than a threshold sound level; and
retaining, based on the determining that the own voice sound level is lower than the threshold sound level, the adjustment to the target signal separation machine learning algorithm.

16. The method of claim 14, wherein the performing the operation with respect to the adjustment comprises:
determining that the own voice sound level is higher than a threshold sound level; and
rejecting, based on the determining that the own voice sound level is higher than the threshold sound level, the adjustment to the target signal separation machine learning algorithm.

17. The method of claim 14, wherein the processor comprises a processor of a computing device external to the hearing device.

18. A hearing device comprising:
a memory that stores instructions; and
a processor communicatively coupled to the memory and configured to execute the instructions to perform a process comprising:
performing an adjustment to a target signal separation algorithm applied to an input signal to the hearing device worn by a user;
determining an own voice sound level representative of a sound level of a voice of the user; and
performing, based on the own voice sound level, an operation with respect to the adjustment.

19. The hearing device of claim 18, wherein the performing the operation with respect to the adjustment comprises:
determining, based on the performing the adjustment to the target signal separation algorithm, that the own voice sound level is lower than a threshold sound level; and
retaining, based on the determining that the own voice sound level is lower than the threshold sound level, the adjustment to the target signal separation algorithm.

20. The hearing device of claim 19, further comprising performing, based on the determining that the own voice sound level is lower than the threshold sound level, a further adjustment based on the adjustment to the target signal separation algorithm.
